(19) United States
(12) Patent Application Publication
(10) Pub. No.: US 2012/0171383 A1
(43) Pub. Date: Jul. 5, 2012

(54) CONFORMAL COATING APPARATUS AND RELATED METHOD

(75) Inventors: Dennis Ronn Christensen, Indianapolis, IN (US); Imran Ahmad, Plainfield, IN (US)

(73) Assignee: Specialty Coating Systems, Inc., Indianapolis, IN (US)

(21) Appl. No.: 12/981,716

(22) Filed: Dec. 30, 2010

(51) Int. Cl. B05D 1/02; B05C 11/10; B05C 13/00; B05C 5/00; B05C 15/00

(52) U.S. Cl. 427/427.3; 118/323

(57) ABSTRACT

A conformal coating apparatus is provided to deposit material on a substrate. The conformal coating apparatus includes a housing, a head configured to deposit material and a movement mechanism coupled to the housing and to the head. The movement mechanism includes a movable member coupled to the head, three actuators coupled to the housing, and three linkages respectively connecting the movable member to the three actuators. A controller is coupled to the movement mechanism and the head. The controller is configured to control the automated movement of the movement mechanism to provide at least x-axis, y-axis and z-axis movement of the head.

### BACKGROUND OF THE INVENTION

1. Field of the Disclosure The present disclosure relates generally to apparatus and methods for dispensing materials on a substrate, and more particularly to an apparatus and related methods for spray coating such materials on substrates.

2. Discussion of Related Art

Conformal coating is used in a variety of industries to protect various substrates from contaminates and damage. Conformal coating apparatus, such as spray coating machines, are well known in the art. Such apparatus may be configured to dispense a variety of materials onto substrates. By selectively spraying a preprogrammed path with a narrow angled spray valve the coating can be placed accurately so that the substrate is coated where necessary and not coated where coating would damage or otherwise negatively effect the function of the part. Typical conformal coating systems use Cartesian-type movement systems configured to achieve movement along three to five axes of movement, and are fitted with a variety of dispensing heads to transfer the material to the substrate in a controlled fashion.

### BRIEF SUMMARY OF THE INVENTION

One aspect of the present disclosure is directed to a conformal coating apparatus for depositing material on a substrate. In one embodiment, the conformal coating apparatus comprises a housing, a head configured to deposit material and a movement mechanism coupled to the housing and to the head. In a certain embodiment, the movement mechanism includes a movable member coupled to the head, at least three actuators coupled to the housing, each actuator having a motor with a rotating portion configured to rotate about an axis of the actuator, and at least three linkages respectively connecting the movable member to the at least three actuators. Each linkage connects the rotating portion of its respective actuator to the movable member. Each linkage has a single bar having a first end a second end. The first end of the single bar is coupled to the rotating portion of its respective actuator. A first articulated connector is coupled to the second end of the single bar. Each linkage further has two parallel bars, each parallel bar having a first end and a second end. The first ends of the two parallel bars are coupled to the first articulated connector. A second articulated connector is coupled to the second ends of the parallel bars and the movable member. A controller is coupled to the movement mechanism and the head. The controller is configured to control the automated movement of the movement mechanism to provide at least x-axis, y-axis and z-axis.

Embodiments of the conformal coating apparatus may further include a substrate support coupled to the housing. The substrate support includes a pair of support elements configured to support one or more substrates and a pair of frame support elements secured to the housing. The frame support elements are configured to support the support elements. The first articulated connector includes an axial bearing member coupled to the single bar and the first ends of the two parallel bars. The axial bearing member has a bearing that enables the axial bearing member to pivot with respect to the single bar. The axial bearing member further has two ends, each end being pivotally connected to the first end of its respective parallel bars. The second articulated connector includes an axial bearing member coupled to the movable member and the second ends of the two parallel bars. The axial bearing member has a bearing that enables the axial bearing member to pivot with respect to the movable member. The axial bearing member further has two ends, each end being pivotally connected to the second end of its respective parallel bars. In one embodiment, the controller is coupled to the at least three actuators. In another embodiment, the head includes a spray valve connected to a material supply. A regulator controls the delivery of material from the material supply to the spray valve. In yet another embodiment, the head includes a dispenser connected to a material supply. A regulator controls the delivery of material from the material supply to the dispenser.

Another aspect of the disclosure is directed to a method of depositing material on a substrate. In one embodiment, the method comprises: positioning a dispensing head (including a spray valve or a dispenser) proximate to a substrate; and controlling the automated movement of the dispensing head to deposit material on the substrate by moving the dispensing head in x-axis, y-axis and z-axis directions. The controlling the automated movement of the dispensing head is achieved by the movement mechanism.

The present disclosure will be more fully understood after a review of the following figures, detailed description and claims.

### BRIEF DESCRIPTION OF THE DRAWINGS

The accompanying drawings are not intended to be drawn to scale. In the drawings, each identical or nearly identical component that is illustrated in various figures is represented by a like numeral. For purposes of clarity, not every component may be labeled in every drawing. Reference is made to the following drawing figures, which are incorporated herein by reference and in which:

FIG. 1 is a front perspective view of an embodiment of a conformal coating apparatus of the present disclosure;

FIG. 2 is a back perspective view of the conformal coating apparatus;

FIG. 3 is an enlarged perspective view of a portion of a movement mechanism of the conformal coating apparatus supporting a spray valve;

FIG. 4 is an enlarged perspective view of a portion of the movement mechanism supporting a dispenser;

FIG. 5 is an enlarged perspective view of a portion of the movement mechanism supporting another type of dispenser;

FIG. 6 is a bottom perspective view of a head connector of the movement mechanism;

FIG. 7 is an exploded enlarged perspective view of an articulating connector of the movement mechanism;

FIG. 8 is a bottom perspective view of a head connector of another embodiment of the movement mechanism;

FIG. 9 is an enlarged perspective view of an articulating connector of another embodiment;

FIG. 10 is an exploded enlarged perspective view of the articulating connector illustrated in FIG. 9; and

FIG. 11 is an exploded enlarged perspective view of the articulating connector illustrated in FIGS. 9 and 10 taken from another angle.

### DETAILED DESCRIPTION OF THE INVENTION

For the purposes of illustration only, and not to limit the generality, the present disclosure will now be described in detail with reference to the accompanying figures. This disclosure is not limited in its application to the details of construction and the arrangement of components set forth in the following description or illustrated in the drawings. The apparatus of embodiments disclosed herein is capable of other embodiments and of being practiced or being carried out in various ways. Also the phraseology and terminology used herein is for the purpose of description and should not be regarded as limiting. The use of “including,” “comprising,” “having,” “containing” “involving,” and variations thereof herein, is meant to encompass the items listed thereafter and equivalents thereof as well as additional items.

For purposes of illustration, embodiments of the present disclosure will now be described with reference to a conformal coating apparatus used to spray coat or otherwise dispense material on an object. With certain applications, conformal coating materials may be applied to printed circuit boards to protect against damage caused by the environment in which the circuit board operates, such as moisture, dust, chemicals and temperature. The coating can be achieved with a conformal coating apparatus that includes a spray valve applicator capable of applying material on the substrate in selective areas. In certain examples, flow rates and material viscosity are programmed into a computer system of the apparatus to control the applicator so that a desired coating thickness is maintained.

In certain embodiments, the material includes parylene. In other embodiments, the material includes room temperature vulcanizing (RTV) silicone rubber, glues, sealants and other liquid coatings. However, other materials, including polymeric materials, may be employed with the apparatus disclosed herein. In other examples, solvent-based, water-based and solid materials may be employed. In other embodiments, objects may include, but are not limited to, electronic substrates, such as semiconductor wafers and printed circuit boards, medical devices, such as stents, and any other object or component requiring thin coatings of material. For example, and without limitation, objects used in the electronics, military, medical and automotive industries may be coated using the apparatus and methods disclosed herein. One skilled in the art will appreciate that embodiments of the present disclosure are not limited to conformal coating apparatus capable of spraying or dispensing protective materials onto electronic substrates, but rather, may be used in any application intended to coat objects.

In addition, although a particular conformal coating apparatus platform is disclosed herein, the conformal coating head of embodiments disclosed herein may be used with other types of platforms designed to manipulate such heads. In one embodiment, the platform may include spray coating platforms sold by Specialty Coating Systems, Inc. of Indianapolis, Ind. under the trade name Precisioncoat.

In a certain embodiment, a conformal coating apparatus includes a housing and a head (such as a spray valve or dispenser) that is configured to dispense or otherwise deposit material. As discussed above, traditional conformal coating machines have a gantry that is configured to provide x-axis, y-axis and z-axis movement. In some embodiments, the traditional gantry may also be configured to rotate about the z-axis and pivot about a point on the z-axis. The conformal coating apparatus of the present disclosure includes a movement mechanism that is coupled to the housing and to the head. The head may be manipulated by a controller coupled to the movement mechanism and the head. Specifically, the controller may be configured to control the automated movement of the movement mechanism to provide nearly unlimited freedom of movement of the head.

In one embodiment, the movement mechanism embodies what is known in the industry as a “delta robot” which is capable of generating three degrees of freedom of movement—three translational. In the past, the delta robot, or a parallel arm robot, was particularly useful in manipulating light and small objects at very high speeds. The delta robot is a parallel robot, which means there is more than one kinematic chain from a base of the robot to a dispensing head. A feature of the delta robot is the use of parallelograms to achieve the four degrees of movement. These parallelograms restrict the movement of the dispensing head to pure translation, i.e., movement in the x-axis, y-axis and z-axis directions. With traditional delta robots, a base of the delta robot is mounted above the workspace. The delta robot includes actuators that are located on the base. The delta robot typically includes three middle jointed arms, which extend from the base. These arms can be made of lightweight composite material. The ends of the three arms are connected to a small platform on which the dispensing head is mounted. Actuation of the input links will move the platform in the x-axis, y-axis and z-axis directions. Actuation can be done with linear or rotational actuators. From the base, a fourth leg extends to the middle of the platform to give the dispensing head a fourth, rotational degree of freedom. Because the actuators are all located in the base, and the arms are made of a composite material the moving parts of the delta robot have a small inertia. This allows for very high accelerations.

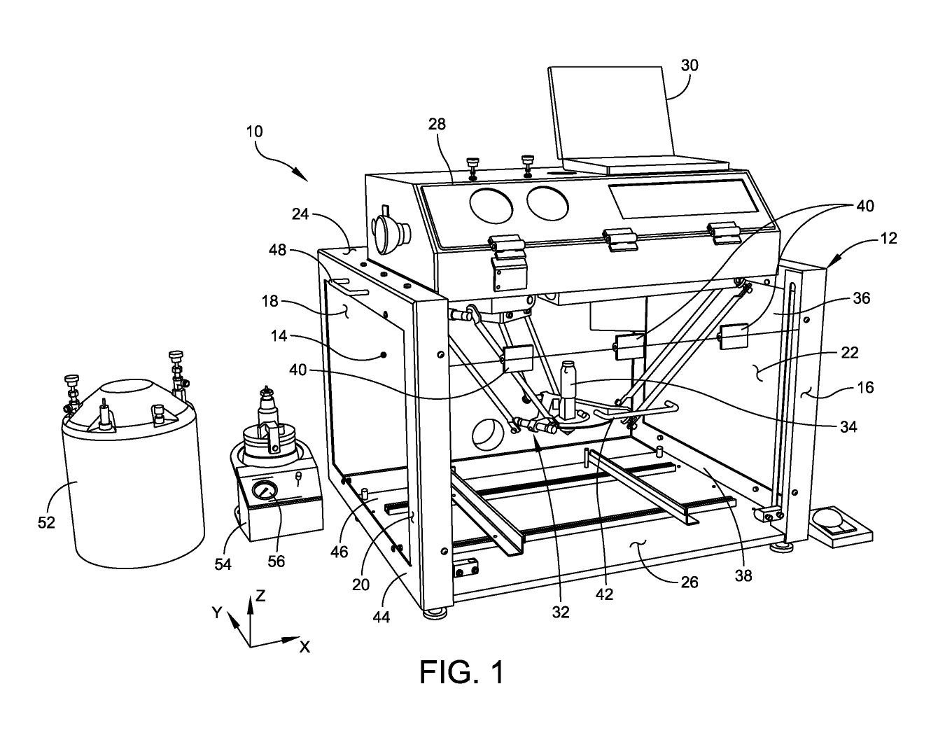

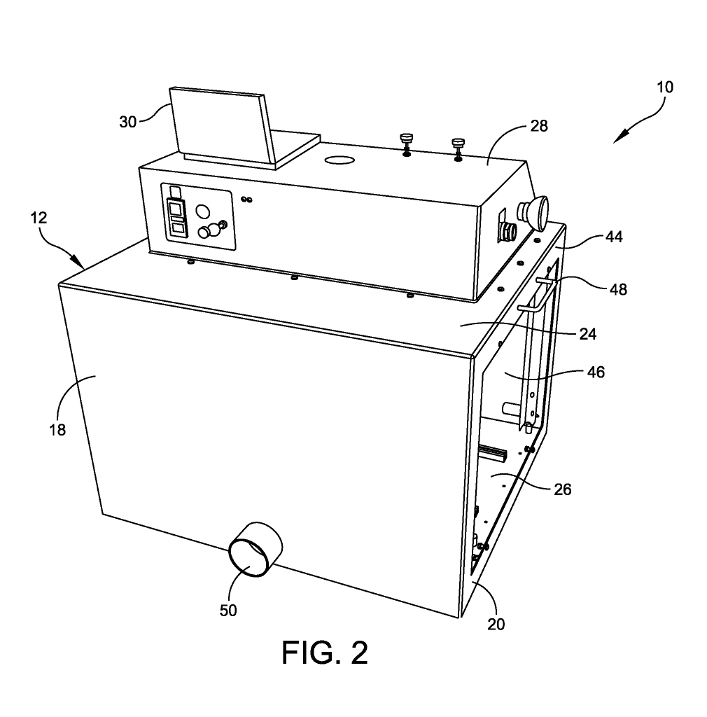

Referring now to the drawings, and more particularly to FIGS. 1 and 2, there is generally indicated at 10 a conformal coating apparatus of an embodiment of the disclosure. As shown, the conformal coating apparatus 10 includes a housing, generally indicated at 12, that supports components of the conformal coating apparatus. The housing 12 is a box-shaped structure that defines an interior working space 14 used to perform conformal coating operations. As shown, the housing 12 includes a front 16, a back 18, two opposite sides 20, 22, a top 24 and a bottom 26. The components, in part, may include a control panel 28 supported by the housing 12 at the top 24 of the housing, a controller 30 in the form of a laptop computer provided on top of the control panel, a movement mechanism, generally indicated at 32, mounted within the interior 14 of the housing to the top 24 of the housing, and a dispensing head 34 coupled to the movement mechanism. The controller 30 is configured to control the operation of the conformal coating apparatus 10. In the shown embodiment, the dispensing head 34 may be mounted on the movement mechanism 32, which enables the dispensing head to be moved in the x-axis, y-axis, z-axis and rotational (when provided) directions under the control of the controller 30.

In one embodiment, the controller 30 may be configured to have a suitable operating system (e.g., Windows XP® offered by Microsoft Corporation of Redmond, Wash.) with application specific software to control the operation of the conformal coating apparatus 10. In a certain embodiment, an operator of the conformal coating apparatus 10 may operate the apparatus either manually by manipulating a keyboard (not shown) and a mouse (not shown) provided with the controller 30 and/or the control panel 28 or automatically by preprogramming the controller by means of the keyboard and mouse through the controller and/or the control panel.

Still referring to FIGS. 1 and 2, the front 16 and sides 20, 22 of the conformal coating apparatus 10 may be accessed through see-through doors hingedly mounted on the housing 12.

Specifically, a front door includes a first panel 36 of see-through material, such as glass or plastic, secured to the front 16 of the housing 12 adjacent the top 24 of the housing, a second, larger panel 38 of see-through material positioned below the first panel of material, and three hinges, each indicated at 40, which hingedly attach the second panel to the first panel. A handle 42 is provided to pivot the second panel 38 about the hinges 40 to access the interior 14 of the housing 12. The sides 20, 22 of the housing 12 each have a door that includes an outer frame 44 and a panel 46 of see-through material supported by the frame. For each side 20, 22, the frame 44 is securely attached to the housing 12 at the side of the housing 12 or, in other embodiments, may be hingedly connected to the housing at the bottom of the side of the housing so that the door is opened by pivoting the door about the bottom of the door. Each side door may include a handle.

As shown in FIG. 2, the back 18 of the housing 12 includes a panel of suitable material, e.g., sheet metal material. The back 18 of the housing 12 includes an opening 50 through which fumes generated from conformal coating operations may be vented from the interior 14 of the housing of the conformal coating apparatus 10 from one of two material supply canisters 52 or 54, which are provided outside the conformal coating apparatus. As shown, the larger canister 52 is provided for supplying a greater amount of material. The smaller canister 54 is also provided. Each canister 52, 54 is configured to supply material under pressure to the dispensing head 34 of the conformal coating apparatus 10. As shown, the smaller canister 54 includes a pressure regulator 56 to regulate the pressure of material being delivered to the dispensing head 34.

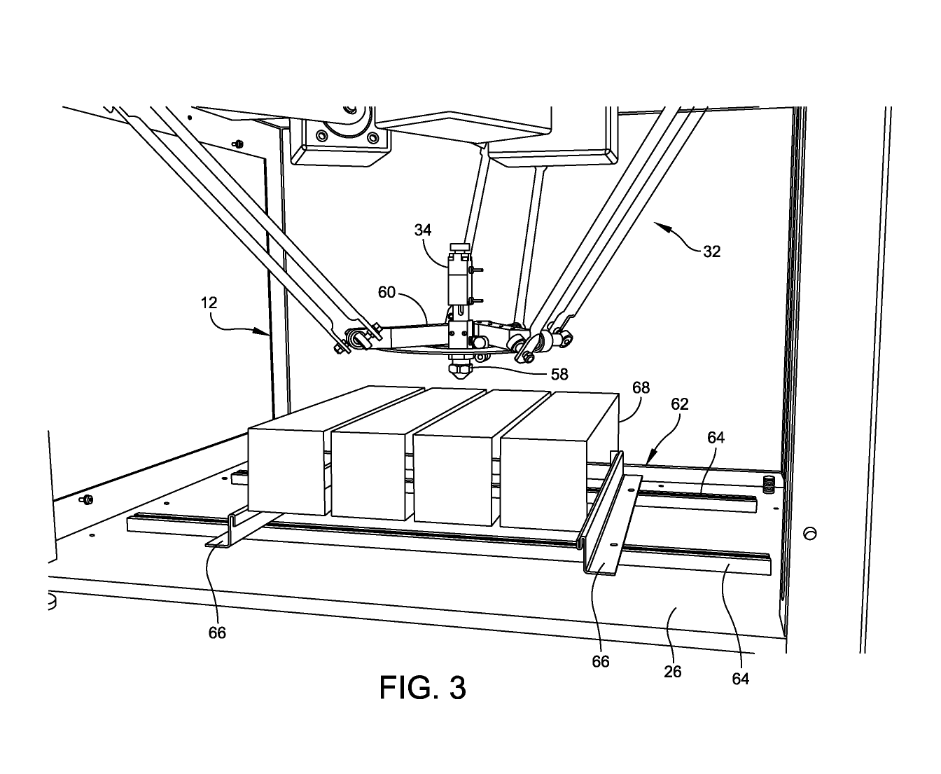

Referring to FIGS. 3-5, and more particularly to FIG. 3, there is illustrated the dispensing head 34 that is configured to include a spray valve 58. As shown, the dispensing head 34 is mounted on a movable member or plate 60 that is moved by the components of the movement mechanism 32. Provided below the dispensing head 34 is a substrate support, generally indicated at 62, which is secured to the bottom 26 of the housing 12 of the conformal coating apparatus 10. As shown, the substrate support 62 includes a first set (two) of rails, each indicated at 64, secured to the bottom 26 of the housing 12. The first set of rails 64 extends in a direction from one side 20 of the housing 12 to the other side 22 of the housing. The substrate support 62 further includes a second set (two) of rails, each indicated at 66, which are supported by the first set of rails 64 and extend in a direction perpendicular to the direction of the first set of rails. The substrate support 62 is designed to support substrates 68 to perform conformal coating operations on the substrates.

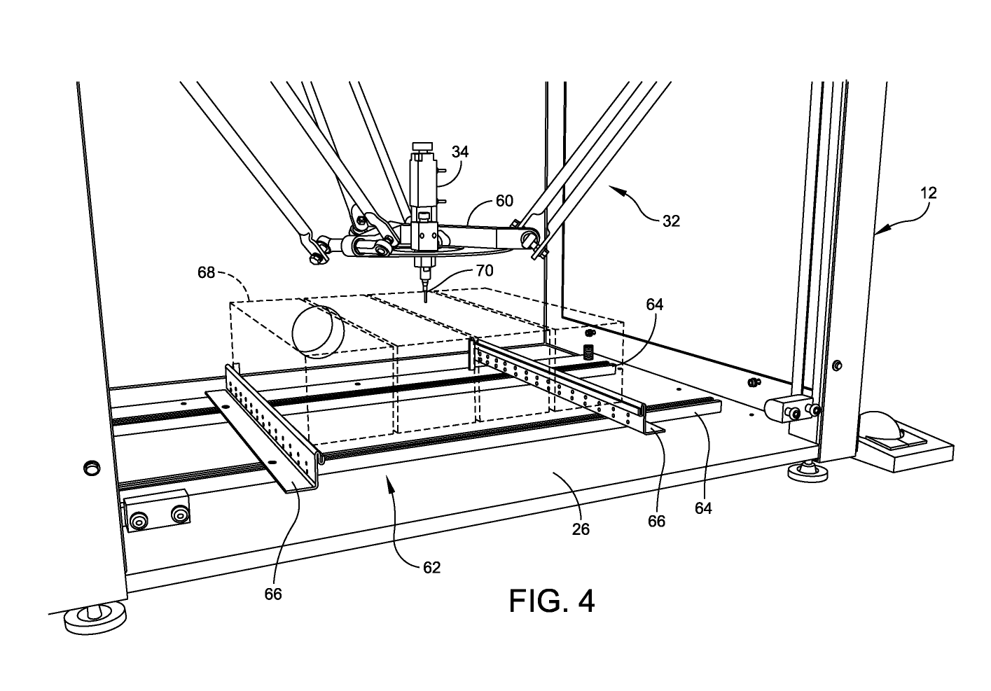

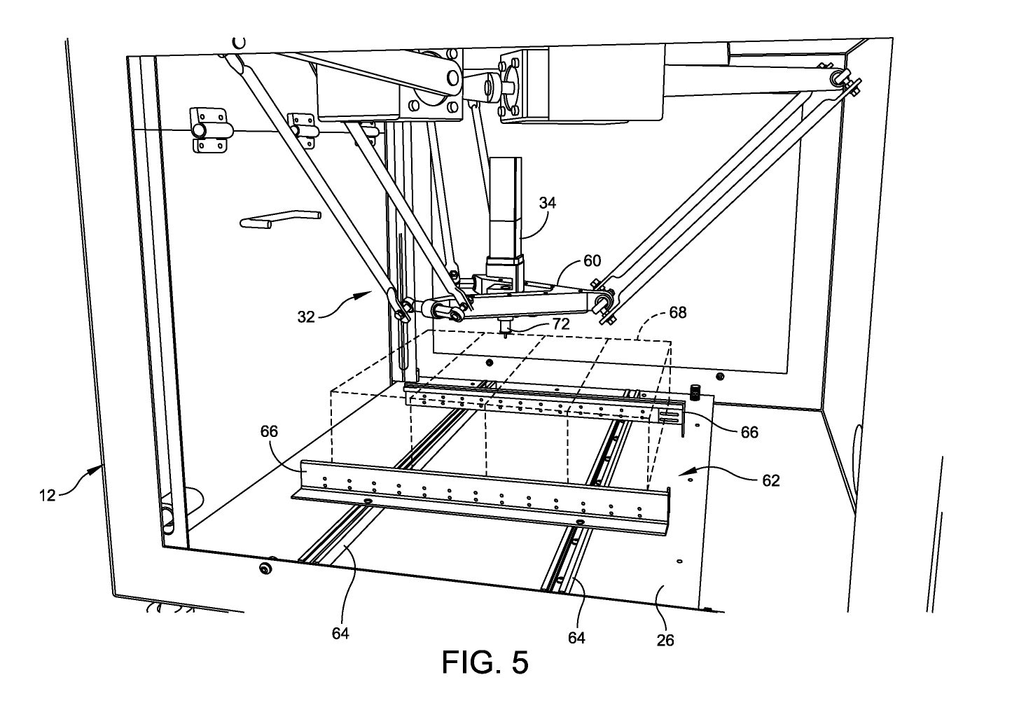

As mentioned above, the dispensing head 34 includes the spray valve 58 that is designed to spray material on the substrates 68 that are positioned on the substrate support 62. FIG. 4 illustrates a dispensing valve or needle 70, which replaces the spray valve 58 shown in FIG. 3. As shown in FIG. 4, the dispensing needle 70 is secured by the movable member 60. FIG. 5 illustrates another type of dispenser, such as an auger dispenser 72, supported by the movable member 60. The type of applicator may be changed to accommodate different materials or to provide different types of material applications. The moveable member 60 is configured to change the applicator. The arrangement is such that the dispensing head 34, including the spray valve 58, dispensing needle 70 and auger dispenser 72 are in fluid communication with the material supply canister 52 or 54 to supply material to the dispensing head. Suitable hoses and connectors may be provided to achieve the fluid communication.

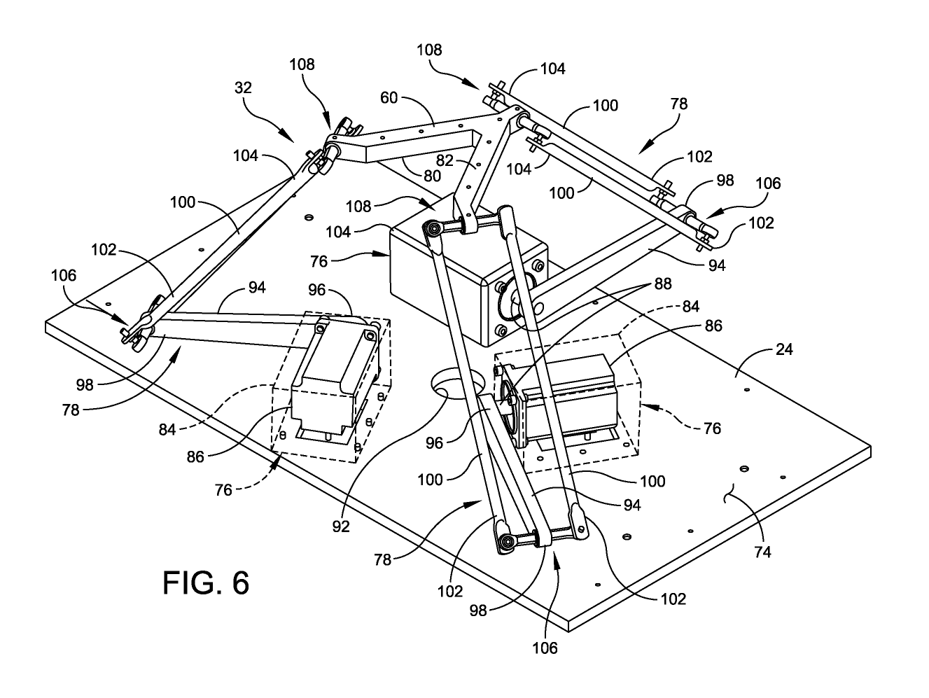

FIG. 6 illustrates the movement mechanism 32 attached to a bottom surface 74 of the top 24 of the housing 12. In one embodiment, the movement mechanism 32 includes the movable member 60, which is configured to support a dispensing head (not shown), three actuators, each generally indicated at 76, and three linkages, each generally indicated at 78. As will be discussed below, the movable member 60 may embody any number of designs suitable for supporting the interchangeable dispensing heads. With the embodiment illustrated in FIGS. 1 and 2-7, the movable member 60 includes two arms 80, 82 fixedly connected to one another to achieve a generally V-shaped configuration. As best shown in FIGS. 3-5, the dispensing head 34 is suitably connected to the movable member 60 at the bottom of the “V” formed by the two arms 80, 82.

Each actuator 76 includes a case 84, which is mounted on the bottom 74 surface of the top 24 of the housing 12. The case 84 supports a motor 86 having a rotating portion 88 that is coupled to its respective linkage 78 and rotates about a long axis of the case 84. The arrangement is such that the rotating portion 88 is coupled to the controller 30 to control the rotation of the rotating portion 88. Openings 90 are provided in the top 24 of the housing 12 so that the actuators 76 may be coupled to the controller 30. Another opening 92 is provided so that material can be fed from the canister 52 or 54 to the dispensing head 34.

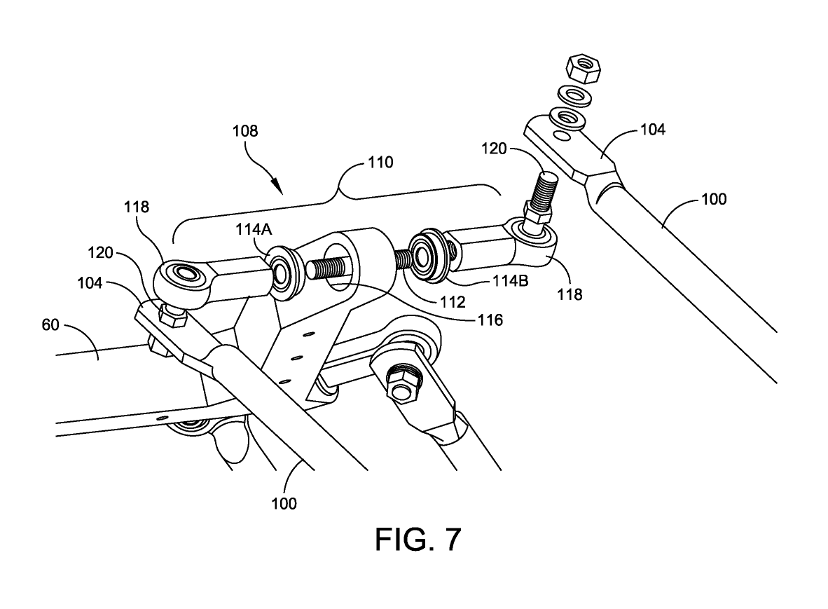

Referring to FIGS. 6 and 7, each linkage 78 includes a single bar 94 having a first end 96 that is connected to the rotating portion 88 and a second end 98. Each linkage 78 further includes two parallel bars, each indicated at 100, each parallel bar having a first end 102 that is connected to the single bar 94 and a second end 104 that is connected to the movable member 60. A first articulated connector, generally indicated at 106, is provided to connect the second end 98 of the single bar 94 to the first ends 102 of the two parallel bars 100. Similarly, a second articulated connector, generally indicated at 108, is provided to connect the second ends 104 of the two parallel bars 100 to the movable member 60. The result is that the single bar 94 and the two parallel bars 100 create a parallel apparatus, which means that there is more than one kinematic chain from the top 24 of the housing 12 to the dispensing head (not shown in FIGS. 6 and 7). The movement mechanism 32 can also be seen as a spatial generalization of a four-bar linkage, which has three degrees of freedom—three translational. The linkages 78 of the movement mechanism 32 create parallelograms, which restrict the movement of the moveable member 60 to pure translation (only movement in the x-, y- or z-direction). The arrangement is such that the movable member 60 operates within the interior of the housing 12 above the substrate support 62. Rotational movement of the dispensing head 34 may be achieved by providing a suitable motor on the movable member 60 to rotate or otherwise manipulate the dispensing head.

As illustrated in FIG. 7, which shows the second articulated connector 108, each articulated connector 106, 108 includes an axial bearing member 110 coupled to either the single bar 94 (for the first articulated connector) or the movable member 60 (for the second articulated connector). The axial bearing member 110 has a rod 112 with threaded end portions and a two-part bearing 114A, 114B that rides along a smooth portion of the middle of the rod. The two-part bearing 114A, 114B is seated within an opening 116 provided in the movable member 60 to enable the rotation of the axial bearing member with respect to the movable member. The rod 112 is connected at each end to a portion, each indicated at 118, having an opening (not designated) provided to attach to the end 104 of one bar 100 of the two parallel bars. Suitable fasteners 120 may be used to make the attachment of the end 104 of the one bar 100 to the portion 118. This construction enables the ends of the axial bearing member 110 to be pivotally connected to the ends 104 of its respective two parallel bars 100. The arrangement is such that the axial bearing member 110 is capable of rotating with respect to the movable member 60. The single bar 94 and the two parallel bars 100 of each linkage 106, 108 are preferably fabricated from lightweight composite material. When activating the actuators 76, the three linkages 78 move the movable member 60 in the x-, y- or z-direction. Because the actuators 76 are all located on the top 24 of the housing 12, and the linkages 78 are made from a composite material, the moving parts of the movement mechanism 32 have a small inertia. This construction allows for very high accelerations, which means faster operation of the conformal coating apparatus 10.

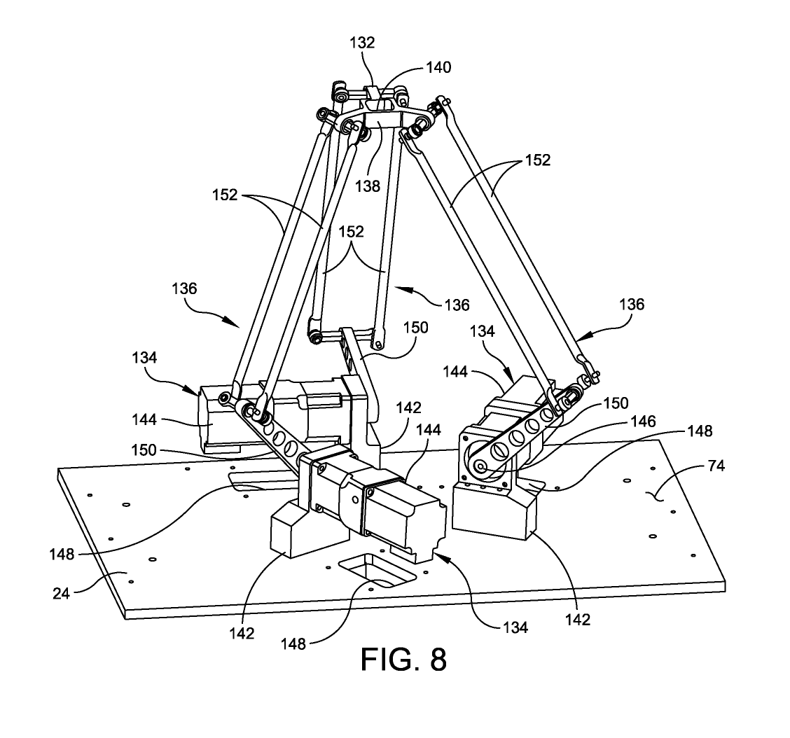

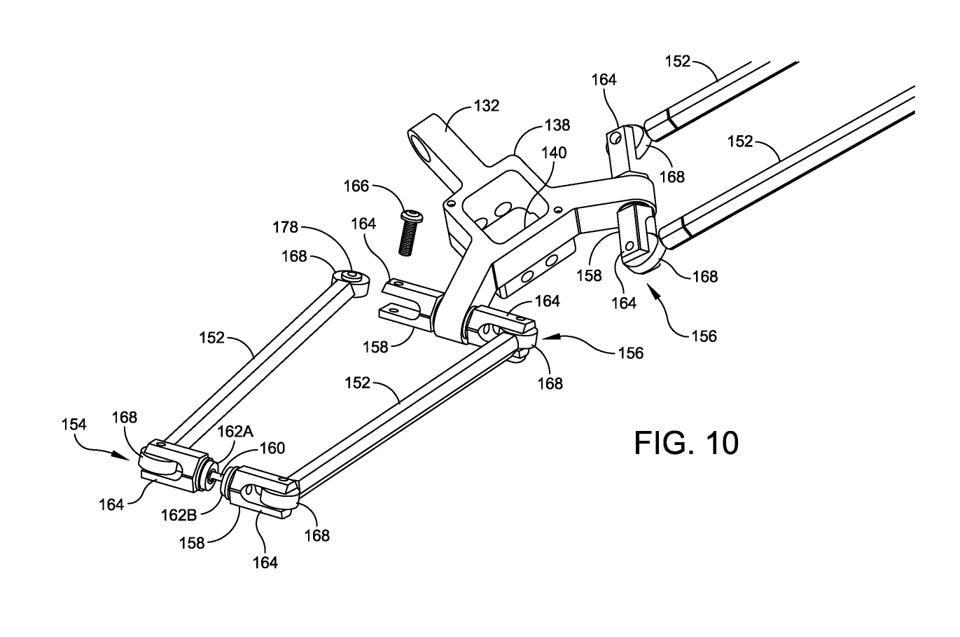

FIGS. 8-11 illustrate another embodiment of a movement mechanism, which is generally indicated at 130 in FIG. 8. The movement mechanism 130 includes a second embodiment of a movable member 132, which is configured to support a dispensing head (not shown), three actuators, each generally indicated at 134, and three linkages, each generally indicated at 136. With the embodiment illustrated in FIGS. 8-11, the movable member 132 includes a central support 138 having a square-shaped opening 140 with three arms (not designated) extending radially from the central support. The dispensing head (not shown in FIG. 8) is connected to the central support 138 of the movable member 132 through the square-shaped opening 140. Each actuator 132 includes a base 142, which is mounted on the bottom surface 74 of the top 24 of the housing 12. A motor 144 is secured to the base 142, the motor 144 having a rotating portion 146 that is coupled to its respective linkage 136 and rotates about a long axis of the actuator 134. The arrangement is such that the rotating portion 146 is coupled to the controller 30 to control the rotation of the rotating portion. Openings 148 are provided in the top 24 of the housing 12 so that the actuators 134 may be coupled to the controller 30.

Each linkage 136 includes a single bar 150 having a first end (not designated) that is connected to the rotating portion 146 and a second end (not designated). Each linkage 136 further includes two parallel bars, each indicated at 152, each parallel bar having a first end (not designated) that is connected to the single bar 150 and a second end (not designated) that is connected to the movable member 132. A first articulated connector, generally indicated at 154, is provided to connect the second end of the single bar 150 to the first ends of the two parallel bars 152. A second articulated connector, generally indicated at 156, is provided to connect the second ends of the two parallel bars 152 to the movable member 132.

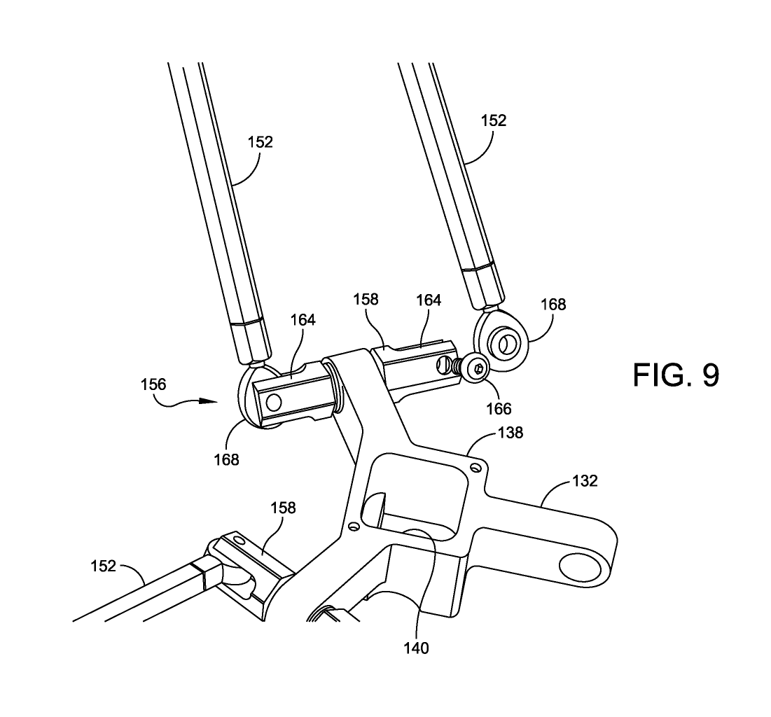

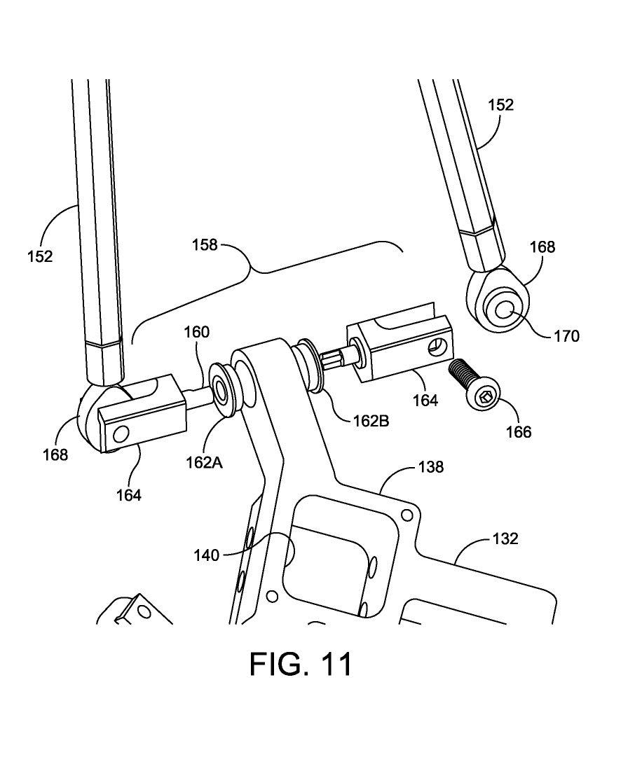

As shown in FIGS. 9-11, each articulated connector 154, 156 includes an axial bearing member 158 coupled to either the single bar 150 (for the first articulated connector) or the movable member 132 (for the second articulated connector). The axial bearing member 158 has a rod 160 (FIG. 11) with threaded end portions and a two-part bearing 162A, 162B that rides along a smooth portion provided at the middle of the rod. The rod 160 is connected at each end to a U-shaped portion 164 having a threaded fastener 166 to attach to the end of one of the two parallel bars 152. As shown in FIG. 11, the end of the bar 152 includes a portion 168 having an opening 170 through which the threaded fastener 166 extends to connect the bar to the U-shaped portion 164. The ends of the axial bearing 158 are pivotally connected to the ends of its respective two parallel bars 152. The arrangement is such that the axial bearing member 158 enables the movable member 132 to pivot with respect to the linkage 136.

When dispensing materials on electronic substrates, such as printed circuit (or wiring) boards, accuracy, functionality and speed are important considerations. In certain embodiments, a conformal coating apparatus includes a spray coating valve that is mounted on a movement mechanism that is capable of providing three axes of movement, i.e., x-axis, y-axis and z-axis movement. Rotational movement may be achieved by a separate motor provided on the moveable member to rotate the dispensing head in a desired direction. In contrast to Cartesian gantry systems providing three axes of movement and having three large and heavy linear actuators arranged in x-axis, y-axis, and z-axis configurations, the apparatus of the present embodiment uses three actuators and linkages to create motion in the three directions with considerably less mass and cost. The configuration of the conformal coating apparatus of the present disclosure is simple in design, and the smooth and quiet motion of the movement system maintains a stable platform that yields more uniform results than conventional selective sprayers.

The conformal coating apparatus of the present disclosure can be configured to include air atomized spraying heads, dispensing heads, swirl-coating nozzles, dual-mode nozzles, and jetting heads. Coating applications using a needle to dispense the material may include needle valves and auger valves. Each of these valves can be mounted on the gantry system or multiple heads can be mounted at the same time. An additional axis of motion can be fitted to the movement system thereby enabling four, five or six axes of motion to further add flexibility to place the coating as necessary on substrates. In such an embodiment, the dispensing head may be configured to provide the one or more additional axes of motion.

The movement system may embody a small tabletop selective coater that has three axes of motion capability and the ability to carry any of the coating technologies disclosed herein. By comparison, Cartesian gantry systems and similar gantries require more space and weigh more to accommodate the same work area. In one embodiment, the housing 12 of the conformal coating apparatus 10 is twenty-eight inches wide by twenty-eight inches deep by twenty-four inches high, and weighs approximately ninety pounds.

During operation, when spraying material on a substrate, the dispensing head is positioned proximate to the substrate. The controller controls the automated movement of the dispensing head to spray material on the substrate by moving the dispensing head in x-axis, y-axis and z-axis directions by means of the movement mechanism. The dispensing head may be configured to spray particular materials. For example, the dispensing head may be configured with a particular type of nozzle suitable for spraying a conformal coating material. In one embodiment, the dispensing head may be an assembly of separate components or provided by a suitable manufacturer, such as EFD, Inc. of East Providence, R.I. or Graco Inc. of North Canton, Ohio.

During operation, when spraying material on a substrate, such as an electronic substrate, the dispensing head is positioned proximate to the substrate. The controller controls the automated movement of the dispensing head to spray material on the substrate by moving the dispensing head in x-axis, y-axis, z-axis directions by means of the movement mechanism. The controller, by means of controlling the operation of the actuators, controls movement (linear and rotational) of the movable member and the dispensing head.

Thus, it should be observed that the apparatus disclosed herein are particularly suited for positioning a dispensing head in a desired position without having to manually manipulate the dispensing head. The controller may be programmed to move the gantry assembly and the device to position the head. The automated movement of the head saves time as well as enables the operation to exactly position the head for optimal operation.

Having thus described at least one embodiment of the present disclosure, various alternations, modifications and improvements will readily occur to those skilled in the art. Such alterations, modifications and improvements are intended to be within the scope and spirit of the disclosure. Accordingly, the foregoing description is by way of example only and is not intended to be limiting. The disclosure's limit is defined only in the following claims and equivalents thereto.

What is claimed is:

1. A conformal coating apparatus for depositing material on a substrate, the conformal coating apparatus comprising:
a housing;
a head configured to deposit material;
a movement mechanism coupled to the housing and to the head, the movement mechanism including
a movable member coupled to the head,
at least three actuators coupled to the housing, each actuator having a motor with a rotating portion configured to rotate about an axis of the actuator,
at least three linkages respectively connecting the movable member to the at least three actuators, each linkage connecting the rotating portion of its respective actuator to the movable member, each linkage having
a single bar having a first end a second end, the first end of the single bar being coupled to the rotating portion of its respective actuator,
a first articulated connector coupled to the second end of the single bar,
two parallel bars, each parallel bar having a first end and a second end, the first ends of the two parallel bars being coupled to the first articulated connector, and
a second articulated connector coupled to the second ends of the parallel bars and the movable member; and
a controller coupled to the movement mechanism and the head, the controller being configured to control the automated movement of the movement mechanism to provide at least x-axis, y-axis and z-axis movement of the head.

2. The conformal coating apparatus of claim 1, wherein the first articulated connector includes an axial bearing member coupled to the single bar and the first ends of the two parallel bars, the axial bearing member having a bearing that enables the axial bearing member to pivot with respect to the single bar.

3. The conformal coating apparatus of claim 2, wherein the axial bearing member further has two ends, each end being pivotally connected to the first end of its respective parallel bars.

4. The conformal coating apparatus of claim 1, wherein the second articulated connector includes an axial bearing member coupled to the movable member and the second ends of the two parallel bars, the axial bearing member having a bearing that enables the axial bearing member to pivot with respect to the movable member.

5. The conformal coating apparatus of claim 4, wherein the axial bearing member further has two ends, each end being pivotally connected to the second end of its respective parallel bars.

6. The conformal coating apparatus of claim 1, the controller is coupled to the at least three actuators.

7. The conformal coating apparatus of claim 1, wherein the head includes one of a spray valve and a dispenser.

8. The conformal coating apparatus of claim 7, wherein the one of the spray valve and the dispenser is connected to a material supply.

9. The conformal coating apparatus of claim 8, wherein a regulator controls the delivery of material from the material supply to the one of the spray valve and the dispenser.

10. The conformal coating apparatus of claim 1, further comprising a substrate support coupled to the housing.

11. The conformal coating apparatus of claim 10, wherein the substrate support includes a pair of support elements configured to support one or more substrates.

12. The conformal coating apparatus of claim 11, wherein the substrate support further includes a pair of frame support elements secured to the housing, the frame support elements being configured to support the support elements.

13. A method of depositing material on a substrate, the method comprising:
positioning a head proximate to a substrate, the head being configured to deposit material; and
controlling the automated movement of the head to deposit material on the substrate by moving the dispensing head in x-axis, y-axis and z-axis directions, controlling the automated movement of the dispensing head being achieved by
a movement mechanism coupled to the dispensing head, the movement mechanism including
a movable member coupled to the dispensing head,
at least three actuators, each actuator having a motor with a rotating portion configured to rotate about an axis of the actuator, and
at least three linkages respectively connecting the movable member to the at least three actuators, and
a controller coupled to the movement mechanism and the dispensing head.

14. The method of claim 13, wherein each linkage connects the rotating portion of its respective actuator to the movable member, each linkage having
a single bar having a first end a second end, the first end of the single bar being coupled to the rotating portion of its respective actuator,
a first articulated connector coupled to the second end of the single bar,
two parallel bars, each parallel bar having a first end and a second end, the first ends of the two parallel bars being coupled to the first articulated connector, and
a second articulated connector coupled to the second ends of the parallel bars and the movable member.

15. The method of claim 14, wherein the first articulated connector includes an axial bearing member coupled to the single bar and the first ends of the two parallel bars, the axial bearing member having a bearing that enables the axial bearing member to rotate with respect to the single bar.

16. The method of claim 15, wherein the axial bearing member further has two ends, each end being pivotally connected to the first end of its respective parallel bars.

17. The method of claim 14, wherein the second articulated connector includes an axial bearing member coupled to the movable member and the second ends of the two parallel bars, the axial bearing member having a bearing that enables the axial bearing member to pivot with respect to the movable member.

18. The method of claim 17, wherein the axial bearing member further has two ends, each end being pivotally connected to the second end of its respective parallel bars.

19. The method of claim 13, wherein the head includes one of a spray valve and a dispenser.

20. The method of claim 19, further comprising regulating the amount of material flowing through the one of the spray valve and the dispenser.
